(19) United States
(12) Patent Application Publication
(10) Pub. No.: US 2015/0381512 A1
(43) Pub. Date: Dec. 31, 2015

(54) METHOD AND APPARATUS FOR DEFERRING TRANSMISSION

(71) Applicant: Newracom Inc., Irvine, CA (US)

(72) Inventors: Hyungu PARK, Daejeon (KR); Yongjin KWON, Daejeon (KR)

(21) Appl. No.: 14/749,093

(22) Filed: Jun. 24, 2015

Related U.S. Application Data
(60) Provisional application No. 62/017,122, filed on Jun. 25, 2014.

(30) Foreign Application Priority Data
Sep. 3, 2014 (KR) 10-2014-0117058

(51) Int. Cl. H04L 12/875; H04L 12/911; H04L 29/06

(52) U.S. Cl. CPC H04L 47/56; H04L 69/22; H04L 47/826; H04W 84/12

(57) ABSTRACT

A transmission deferring method is provided by a device in a WLAN. The device receives a frame including duration information indicating transmission deferring duration and address information indicating an address of a target device for the transmission deferring duration, and defers a transmission to the target device during the transmission deferring duration.

### CROSS-REFERENCE TO RELATED APPLICATION

This application claims priority to and the benefit of U.S. Provisional Application No. 62/017,122, filed on Jun. 25, 2014 in the U.S. Patent and Trademark Office and priority to and the benefit of Korean Patent Application No. 10-2014-0117058, filed on Sep. 3, 2014 in the Korean Intellectual Property Office, the entire contents of which are incorporated herein by reference.

### BACKGROUND

(a) Field

The described technology relates generally to a transmission deferring method and apparatus. More particularly, the described technology relates generally to a transmission deferring method and apparatus in a wireless local area network (WLAN).

(b) Description of the Related Art

A frequency band used in the WLAN is an unlicensed band, and other wireless devices, for example Bluetooth devices besides WLAN devices can use the same frequency band. Therefore, the WLAN devices use a carrier sense multiple access (CSMA) protocol to avoid collisions with the other WLAN devices or the other wireless devices. In the CSMA protocol, the WLAN device detects energy on a channel and transmits the signal only when the channel is not being used. In this case, the WLAN device occupies the channel by transmitting a request to send (RTS) frame or a clear to send (CTS) frame. The other device sets a network allocation vector (NAV) based on a duration field of the RTS frame or CTS frame and can operate in a power saving mode without the contention for a channel access during the NAV duration.

Recently, a single chipset into which a WLAN module and a Bluetooth module are incorporated is being developed. The single chipset may transmit or receive WLAN packets and Bluetooth packets by using one a radio frequency (RF) transceiver, for the cost saving. Therefore, when a device using the single chipset attempts to transmit the Bluetooth packet, the WLAN module of the device transmits the CTS frame to cause the other WLAN devices to set the NAVs. That is, the device can prevent the other WLAN devices from using the channel by using the NAVs and transmit or receive the Bluetooth packet.

The Bluetooth uses a synchronous connection oriented (SCO) link for exchanging packets through time slots that are periodically reserved. In the case that the NAV is set, there are merits that no WLAN packet toward the single chipset device occurs when the SCO link of the single chipset device exchanges the packets, but there is a problem that the channel is not efficiently used since the other WLAN devices operate in the power saving mode.

### SUMMARY

An embodiment of the present invention provides a transmission deferring method and apparatus for efficiently using a channel.

According to another embodiment of the present invention, a transmission deferring method is provided by a device in a WLAN. The method includes receiving a frame including duration information indicating transmission deferring duration and address information indicating an address of a target device for the transmission deferring duration, and deferring a transmission to the target device during the transmission deferring duration.

Receiving the frame may include receiving the frame when the device is associated with the target device.

The frame may further include type information. In this case, deferring the transmission may include checking the type information of the frame, and deferring the transmission to the target device during the transmission deferring duration when the type information indicates a frame requesting transmission deferring.

The frame may further include response indication information. In this case, deferring the transmission may include checking the response indication information of the frame, transmitting a response frame to the target device when the response indication information requests a response, and deferring the transmission to the target device during the transmission deferring duration after transmitting the response frame.

The frame may further include receiver address information. In this case, deferring the transmission may include checking the receiver address information of the frame, and deferring the transmission to the target device during the transmission deferring duration when the receiver address information indicates an address of the device.

Further, checking the receiver address information of the frame may include determining that the receiver address information indicates the address of the device when the receiver address information has a value corresponding to the address of the device or a predetermined value.

In this case, the frame may further include response indication information, and deferring the transmission may include checking the response indication information of the frame, transmitting a response frame to the target device when the response indication information requests a response and the receiver address information has the value corresponding to the address of the device, and deferring the transmission to the target device during the transmission deferring duration after transmitting the response frame.

The frame may be a medium access control (MAC) frame.

In this case, the frame may have a same format a frame defined in IEEE Std 802.11-2012, the duration information may be assigned to a reserved value in a duration/ID field of a frame defined in IEEE Std 802.11-2012, and the address information may be assigned to a receiver address (RA) field of a frame defined in IEEE Std 802.11-2012.

The frame may be a physical layer frame. In this case, the duration information and the address information may be assigned to a signal field of the physical layer frame.

According to yet another embodiment of the present invention, a transmission deferring method is provided by a device in a WLAN. The method includes generating a frame including duration information indicating transmission deferring duration and address information indicating an address of a target device requesting transmission deferring during the transmission deferring duration, and transmitting the frame.

The frame may further include type information indicating that the frame has a type requesting the transmission deferring.

The frame may further include response indication information requesting a response on the frame.

The frame may further include receiver address information indicating a receiving device for deferring a transmission to the target device.

In this case, the receiving device may defer the transmission to the target device during the transmission deferring duration when the receiver address information has a value corresponding to the address of the device or a predetermined value.

Further, the frame may further include response indication information requesting a response on the frame, and the receiving device may transmit the response to the device when the receiver address information has the value corresponding to the address of the device.

The frame may be a MAC frame.

In this case, the frame may have a same format a frame defined in IEEE Std 802.11-2012, the duration information may be assigned to a reserved value in a duration/ID field of a frame defined in IEEE Std 802.11-2012, and the address information may be assigned to a receiver address (RA) field of a frame defined in IEEE Std 802.11-2012.

The frame may be a physical layer frame, and the duration information and the address information may be assigned to a signal field of the physical layer frame.

According to still another embodiment of the present invention, a transmission deferring apparatus is provided in a WLAN. The apparatus includes a processor and a transceiver. The transceiver receives a frame including duration information indicating transmission deferring duration and address information indicating an address of a target device for the transmission deferring duration, and the processor defers a transmission to the target device during the transmission deferring duration.

According to further embodiment of the present invention, a transmission deferring apparatus is provided in a WLAN. The apparatus includes a processor and a transceiver. The processor generates a frame including duration information indicating transmission deferring duration and address information indicating an address of a device requesting transmission deferring during the transmission deferring duration, and the transceiver transmits the frame.

### BRIEF DESCRIPTION OF THE DRAWINGS

FIG. 1 and FIG. 2 show examples of a wireless communication network according to an embodiment of the present invention.

FIG. 3, FIG. 4, FIG. 5, FIG. 6, FIG. 7, FIG. 8, FIG. 9, and FIG. 10 each schematically show a frame structure in a wireless communication network according to various embodiments of the present invention.

FIG. 11 is a drawing for explaining a transmission deferring method in a wireless communication network according to an embodiment of the present invention.

FIG. 12 shows a transmission deferring request by a STA in a wireless communication network according to an embodiment of the present invention.

FIG. 13, FIG. 14, FIG. 15, and FIG. 16 each are a flowchart showing a transmission deferring method in a wireless communication network according to various embodiments of the present invention.

FIG. 17 shows a transmission deferring request by an AP in a wireless communication network according to an embodiment of the present invention.

FIG. 18, FIG. 19, FIG. 20, and FIG. 21 each are a flowchart showing a transmission deferring method in a wireless communication network according to various embodiments of the present invention.

FIG. 22 is a schematic block diagram showing a transmission deferring apparatus in a wireless communication network according to an embodiment of the present invention.

### DETAILED DESCRIPTION OF THE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

A WLAN standard defines a data frame, a control frame, and a management frame as frames exchanged between devices. The data frame is used for transmission of data forwarded to a higher layer, and a WLAN device transmits the data frame after performing backoff if an interframe space (IFS) has elapsed. The management frame is used for exchanging management information which is not forwarded to the higher layer, and the WLAN device transmits the management frame after performing backoff if the IFS such as a distributed coordination function interframe space (DIFS) or a point coordination function interframe space (PIFS) has elapsed. The control frame is used for controlling access to the medium. When the control frame is not a response frame of the other frame, the WLAN device transmits the control frame after performing backoff if the IFS has elapsed. When the control frame is the response frame of the other frame, the WLAN device transmits the control frame without performing backoff if a short IFS (SIFS) has elapsed.

A frame control field in a frame includes type and subtype fields for identifying a function of the frame. The type field identifies any one of three types including the control frame, the data frame, and the management frame. Each of the types has several predefined subtypes shown in Table 1, and the subtype is identified by the subtype field.

TABLE 1

| Type | | Subtype | |
|---|---|---|---|
| value | Type | value | |
| b3 b2 | description | b7 b6 b5 b4 | Subtype description |
| 00 | Management | 0000 | Association request |
| 00 | Management | 0001 | Association response |
| 00 | Management | 0010 | Reassociation request |
| 00 | Management | 0011 | Reassociation response |
| 00 | Management | 0100 | Probe request |
| 00 | Management | 0101 | Probe response |
| 00 | Management | 0110 | Timing Advertisement |
| 00 | Management | 0111 | Reserved |
| 00 | Management | 1000 | Beacon |
| 00 | Management | 1001 | ATIM |
| 00 | Management | 1010 | Disassociation |
| 00 | Management | 1011 | Authentication |
| 00 | Management | 1100 | Deauthentication |
| 00 | Management | 1101 | Action |
| 00 | Management | 1110 | Action No Ack |
| 00 | Management | 1111 | Reserved |
| 01 | Control | 0000-0011 | Reserved |
| 01 | Control | 0100 | Beamforming Report Poll |
| 01 | Control | 0101 | VHT NDP Announcement |
| 01 | Control | 0111 | Control Wrapper |
| 01 | Control | 1000 | Block Ack Request |
| | | | (BlockAckReq) |
| 01 | Control | 1001 | Block Ack (BlockAck) |
| 01 | Control | 1010 | PS-Poll |
| 01 | Control | 1011 | RTS |
| 01 | Control | 1100 | CTS |
| 01 | Control | 1101 | ACK |
| 01 | Control | 1110 | CF-End |
| 01 | Control | 1111 | CF-End + CF-Ack |
| 10 | Data | 0000 | Data |
| 10 | Data | 0001 | Data + CF-Ack |
| 10 | Data | 0010 | Data + CF-Poll |
| 10 | Data | 0011 | Data + CF-Ack + CF-Poll |
| 10 | Data | 0100 | Null (no data) |
| 10 | Data | 0101 | CF-Ack (no data) |
| 10 | Data | 0110 | CF-Poll (no data) |
| 10 | Data | 0111 | CF-Ack + CF-Poll (no data) |
| 10 | Data | 1000 | QoS Data |
| 10 | Data | 1001 | QoS Data + CF-Ack |
| 10 | Data | 1010 | QoS Data + CF-Poll |
| 10 | Data | 1011 | QoS Data + CF-Ack + CF-Poll |
| 10 | Data | 1100 | QoS Null (no data) |
| 10 | Data | 1101 | Reserved |
| 10 | Data | 1110 | QoS CF-Poll (no data) |
| 10 | Data | 1111 | QoS CF-Ack + CF-Poll (no data) |
| 11 | Reserved | 0000-1111 | Reserved |

Now, a transmission deferring method and apparatus according to an embodiment of the present invention will be described with reference to the drawings.

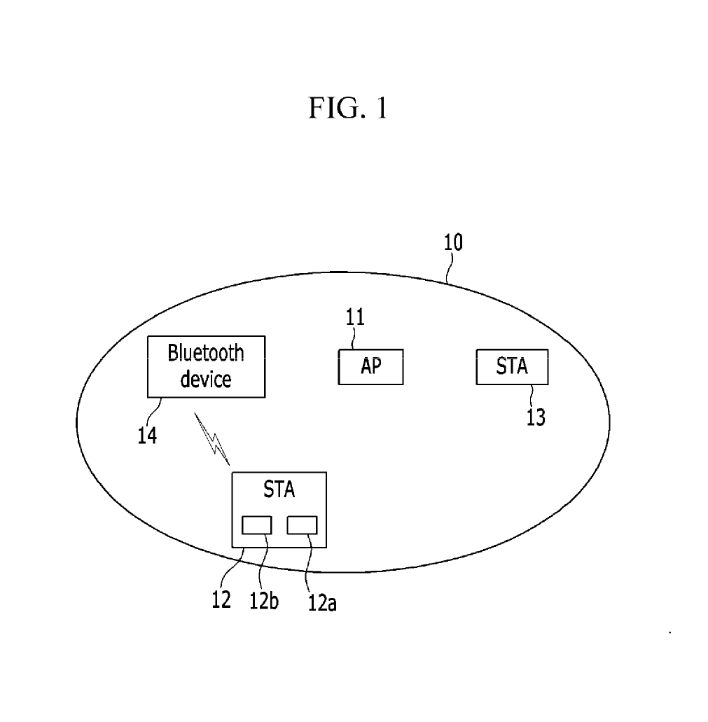

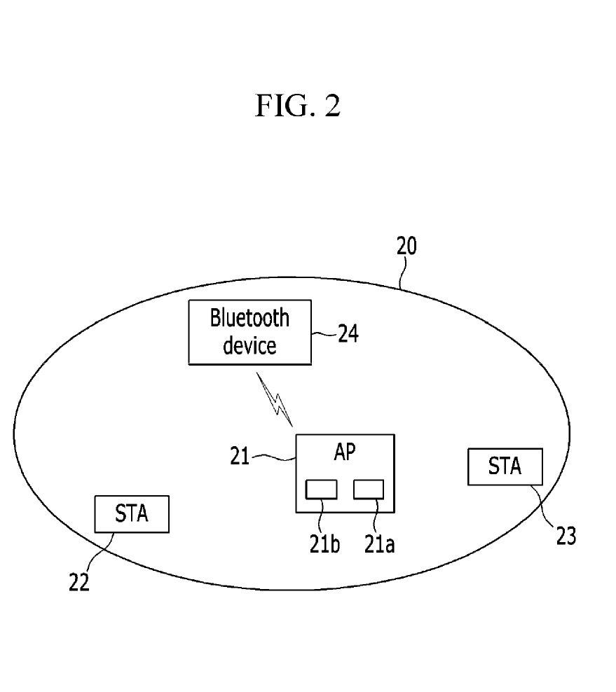

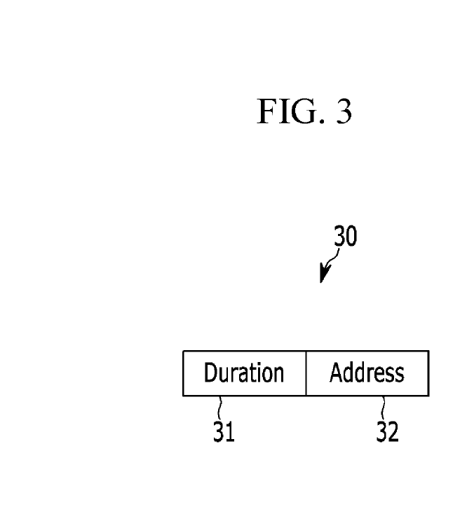

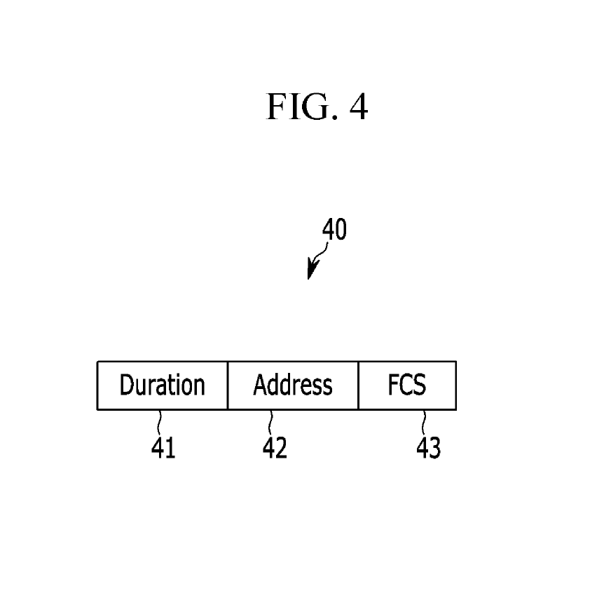

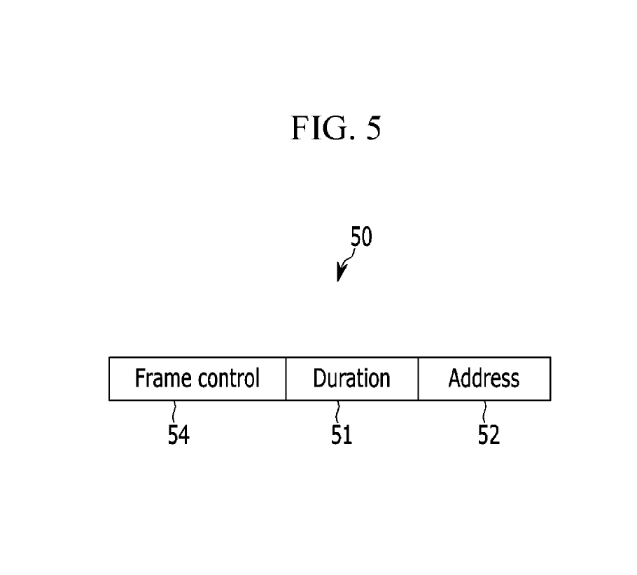

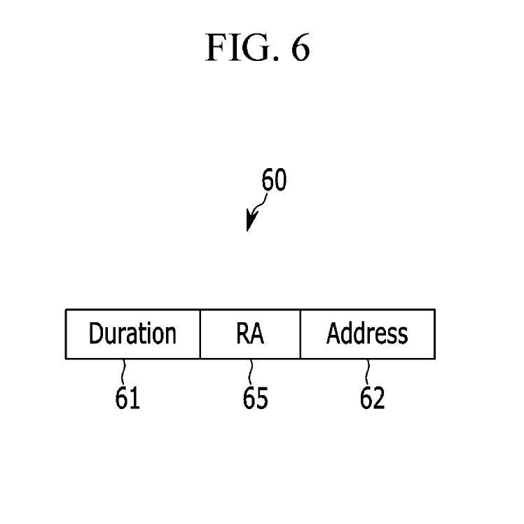

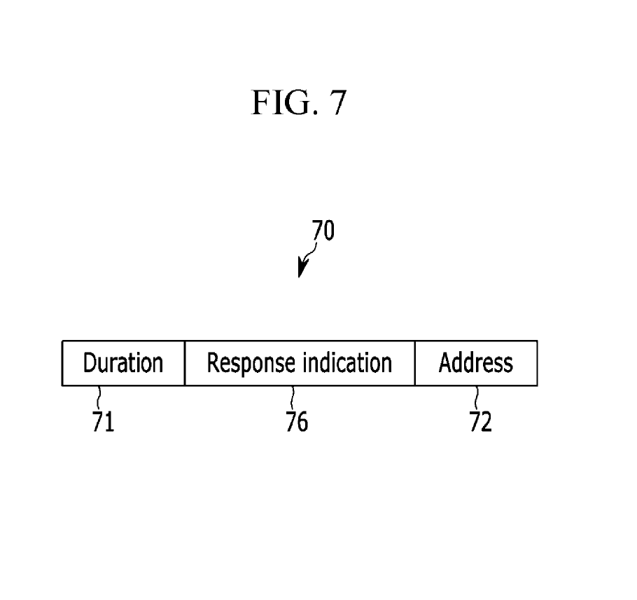

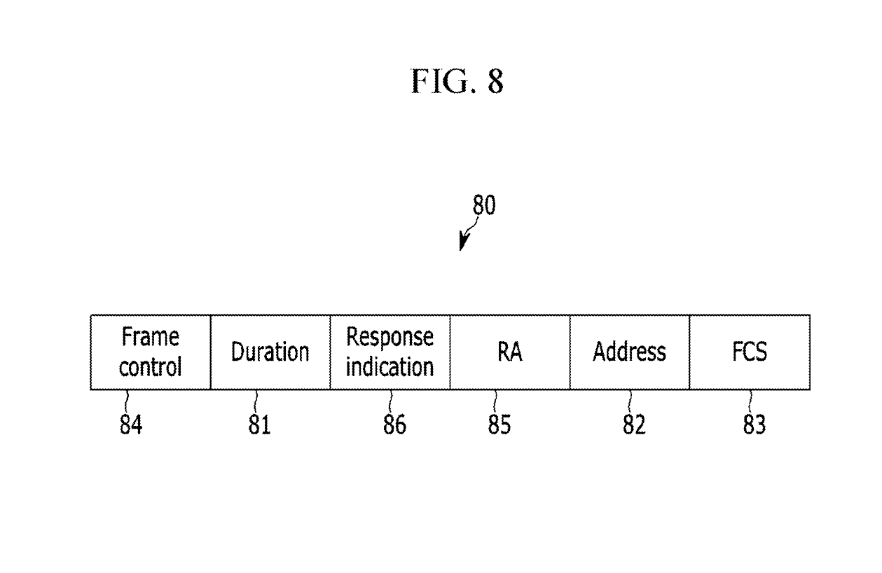

FIG. 1 and FIG. 2 show examples of a wireless communication network according to an embodiment of the present invention, and FIG. 3 schematically shows a frame format in a wireless communication network according to an embodiment of the present invention.

Referring to FIG. 1, a basic service set (BSS) 10 includes a plurality of devices. The plurality of devices include a device that is an access point (AP) 11 and devices that are non-AP stations 12 and 13. Hereinafter, the non-AP station is referred to as the station (STA).

The AP 11 and the STAs 12 and 13 support a wireless communication network according to an embodiment of the present invention. For example, the wireless communication network according to an embodiment of the present invention may be a high efficiency WLAN (HEW) that is being developed by the IEEE 802.11ax task group. Hereinafter, the wireless communication network according to an embodiment of the present invention is assumed as the HEW for convenience.

The BSS 10 may further include previous version STAs. The previous version STAs may include, for example, a STA (hereinafter referred to as a “legacy-STA”) 13 supporting IEEE standard 802.11a or 802.11g (IEEE Std 802.11a-1999 or IEEE Std 802.11g-2003), a STA (hereinafter referred to as an “HT-STA”) 14 supporting IEEE standard 802.11n (IEEE Std 802.11n-2009) for enhancements for higher throughput (HT), or a STA (hereinafter referred to as a “VHT-STA”) 15 supporting IEEE standard 802.11ac (IEEE Std 802.11ac-2013) for enhancements for very high throughput (VHT).

The STA 12 includes a WLAN module 12a and other wireless communication module 12b. Hereinafter, a Bluetooth module is described as an example of the other wireless communication module 12b. The STA 12 can communicate with a Bluetooth device 14 through the Bluetooth module 12b.

Referring to FIG. 2, a BSS 20 includes an AP 21 supporting the HEW and STAs 22 and 23 supporting the HEW. The BSS 20 may further include a previous version STA, and the previous version STA may include, for example, a legacy-STA, an HT-STA, or a VHT-STA.

The AP 21 includes a WLAN module 21a and other wireless communication module 21b. Hereinafter, a Bluetooth module is described as an example of the other wireless communication module 21b. The AP 21 can communicate with a Bluetooth device 24 through the Bluetooth module 21b.

In an embodiment of the present invention, the STA 12 or the AP 21 transmits a frame 30 as shown in FIG. 3. One example of the frame 30 may be a medium access control (MAC) frame such as a control frame, a management frame or a data frame.

Referring to FIG. 3, the frame 30 includes a duration field 31 and an address field 32. The duration field 31 includes duration information indicating a transmission deferring duration, and the address field 32 includes address information indicating an address of a STA or an AP to which the transmission deferring duration indicated by the duration field 31 is applied. When the frame is the MAC frame, the duration field 31 and the address field 32 may be included in a MAC header. An AP or a STA receiving the frame 30 defers a transmission to the device indicated by the address field 32 during the transmission deferring duration indicated by the duration field 31.

In one embodiment, the transmission deferring duration may be the time in microseconds. In another embodiment, the transmission deferring duration may be set to a value corresponding to a duration during which a Bluetooth packet is transmitted in an SCO link.

Therefore, the STA 12 or AP 21 may transmit the frame 30 when it attempts to enter a power saving mode in order to transmit the Bluetooth packet. The power saving mode may be a mode in which an operation different from an operation according to the WLAN module is performed. Duration of the power saving mode, i.e., a value corresponding to the transmission deferring duration is input to the duration field 31, and an address of the STA 12 or AP 21 transmitting the frame 30 is input to the address field 32. Then, the AP or STA receiving the frame 30 does not transmit a packet to the device (i.e., the STA 12 or AP 21) having the address indicated by the address field 32 during duration indicated by the duration field 31.

Accordingly, the STA 12 or AP 21 can perform the other operation, for example an operation for transmitting the Bluetooth packet while operating the WLAN module 12a or 21a in the power saving mode. Since NAVs are not set by the STA 12 or AP 21 in other STA or AP within the transmission coverage of the STA 12 or AP 21, the other STA or AP can detect energy in the channel and occupy the channel when the channel is not in use. However, the other STA or AP does not transmit a packet to the STA 12 or AP 21. Further, since the previous version STA or AP cannot interpret the frame 30, it can detect energy in the channel and occupy the channel when the channel is not in use, regardless of the frame 30.

Furthermore, the STA 12 or AP 21 can set the transmission deferring duration to be short, thereby requesting to defer the transmission and entering the power saving mode during a short period due to the reason such as transmission of the Bluetooth packet.

FIG. 4, FIG. 5, FIG. 6, FIG. 7, and FIG. 8 each schematically show a frame format in a wireless communication network according to various embodiments of the present invention. One example of a frame shown in FIG. 4 to FIG. 8 may be a MAC frame.

Referring to FIG. 4, a frame 40 according to one embodiment includes a duration field 41, an address field 42, and a frame check sequence (FCS) field 43. The FCS field 43 is positioned at an end of the frame 40 and may include a cyclic redundancy check (CRC), for example a 32-bit CRC. The CRC may be calculated over all fields of an MAC header and a frame body of the frame 40.

Accordingly, an STA or AP can check the received frame 40 by using the FCS.

Referring to FIG. 5, a frame 50 according to another embodiment includes a duration field 51, an address field 52, and a frame control field 54. The frame control field 54 includes information indicating a type of the frame 50.

In some embodiments, the frame control field 54 may include type and subtype field for indicating the type of the frame 50. The type field indicates any one of a control frame, a data frame, and a management frame. The subtype field indicates any one of predefined subtypes. Since the frame 50 may be the control frame or the management frame, the type field of the frame 50 may have a value for indicating the control frame or the management frame. The subtype field may have a value for indicating a frame described in an embodiment of the present invention.

An AP or STA receiving the frame 50 identifies the type of the frame 50 from the frame control field 54. When the frame 50 is a transmission deferring request frame, the AP or STA cannot transmit a packet to a device having an address indicated by the address field 52 during transmission deferring duration indicated by the duration field 51.

Referring to FIG. 6, a frame 60 according to yet another embodiment includes a duration field 61, an address field 62, and a receiver address (RA) field 65. The RA field 65 includes RA information indicating an address of a STA or AP that cannot transmit a packet to an AP or STA transmitting the frame 60 during transmission deferring duration indicated by the duration field 61.

When an AP transmits the frame 60, the RA field 65 may indicate an address of a STA. In this case, only the STA having an address indicated by the RA field 65 cannot transmit an uplink packet to the AP during transmission deferring duration indicated by the duration field 61 but the other STA within a BSS can transmit an uplink packet to the AP. In another embodiment, the RA field 65 may include an association identifier (AID) between the AP and the STA, instead of the address of the STA. Since the AID is an identifier which the AP has allocated to the STA during an association of the STP to the AP, the STA can be identified by the AID.

In yet another embodiment, when a STA transmits the frame 60, the RA field 65 may indicate an address of an AP. In this case, only the AP having an address indicated by the RA field 65 cannot transmit a downlink packet to the STA during transmission deferring duration indicated by the duration field 61. In still another embodiment, when a direct communication can be performed between STAs, the RA field 65 may indicate an address of a STA.

In further embodiment, when the RA field 65 has a predetermined value, all devices within the BSS may not transmit a packet to an AP or STA indicated by the address field 62.

In some embodiments, the RA field 65 may have 6 octets and may be defined as in Table 2.

TABLE 2

| TX | RA field | Address field | Meaning |
|---|---|---|---|
| AP | FFFFFFFFFFFF | Transmitter | Request that an AP does not |
| | | AP address | transmit an uplink packet to all |
| | | | STAs within a BSS during |
| | | | transmission deferring duration |
| AP | STA address or | Transmitter | Request that an AP does not |
| | AID | AP address | transmit an uplink packet to a |
| | | | STA within a BSS indicated by |
| | | | RA field during transmission |
| | | | deferring duration |
| STA | FFFFFFFFFFFF | Transmitter | Request that a STA does not |
| | | STA address | transmit a downlink packet to an |
| | | | AP during transmission |
| | | | deferring duration |
| STA | AP address | Transmitter | Request that a STA does not |
| | | STA address | transmit a downlink packet to an |
| | | | AP indicated by RA field during |
| | | | transmission deferring duration |

Referring to FIG. 7, a frame 70 according to still another embodiment includes a duration field 71, an address field 72, and a response indication field 76. The response indication field 76 includes response indication information indicating whether a response to the frame 70 is required. When the frame 70 is a MAC frame, the response indication field 76 may be included in a frame body.

When the response indication field 76 indicates that the response is required, an AP or STA transmitting the frame 70 enters a power saving mode after receiving a response frame from a STA or AP receiving the frame 70. As such, the power saving mode can be stably operated because the transmitter and the receiver of the frame 70 can agree with entering the power saving mode through the response frame.

When the response indication field 76 indicates that the response is not required, the AP or STA enter the power saving mode without confirmation on the response frame after transmitting the frame 70.

In one embodiment, when the frame 70 includes an RA field shown in FIG. 6, the response indication field 76 may have a value for indicating that the response is required if the RA field 65 indicates a specific AP or STA address.

In another embodiment, when response indication field 76 is not used or indicates that the response is not required, the AP or STA can quickly enter the power saving mode without confirming the response frame.

Referring to FIG. 8, a frame 80 according to further embodiment includes a duration field 81 and an address field 82, and further includes an FCS field 83, a frame control field 84, an RA field 85, and/or a response indication field 86.

According to an embodiment of the present invention, a transmission deferring request frame may be defined as a new MAC frame. For example, when the new MAC frame is a control frame, any one of reserved values “0000”, “0001”, “0010”, and “0011” of the subtype field in Table 1 may be assigned to the new MAC frame. When the new MAC frame is a management frame, a reserved value “1111” of the subtype field in Table 1 may be assigned to the new MAC frame.

FIG. 9 schematically shows a frame format in a wireless communication network according to another embodiment of the present invention.

Referring to FIG. 9, a frame 90 has the same format as the previous version WLAN, for example the IEEE standard 802.11a, the IEEE standard 802.11g, the IEEE standard 802.11n, or the IEEE standard 802.11ac.

The frame 90 includes a frame control field 91, a duration/ID field 92, an RA field 93, transmitter address (TA) field 94, and an FCS field 95.

The frame control field 91 indicates a type of the frame 90 and includes type and subtype fields. The type field indicates any one of a control frame, a data frame, and a management frame. The subtype field indicates any one of predefined subtypes. The type of the frame 90 may be indicated by any one of reserved values in the subtype field of the previous version WLAN.

The duration/ID field 92 of the previous version WLAN carries an AID of a STA or indicates duration defined according to the type of the frame. Transmission deferring duration may be indicated by using a reserved value of the duration/ID field 92 in the previous version WLAN.

The duration/ID field 92 in the previous version WLAN is defined as in Table 3. Table 3 is a table defined in the IEEE standard 802.11 (IEEE std 802.11-2012) into which the IEEE standard 802.11a, the IEEE standard 802.11g, and the IEEE standard 802.11n are incorporated.

For example, the transmission deferring duration may be indicated by using values of 1 to 16383 of bits 0-13 after a bit 14 is set to 0 and a bit 15 is set to 1 in Table 3. Alternatively, the transmission deferring duration may be indicated by using values of 2008 to 16383 of bits 0-13 after the bit 14 is set to 1 and the bit 15 is set to 1 in Table 3. Alternatively, the transmission deferring duration may be indicated by using the reserved values of Table 3.

TABLE 3

| | Bit | Bit | |
|---|---|---|---|
| Bits 0-13 | 14 | 15 | Usage |
| 0-32767 | | 0 | Duration value (in microseconds) within all |
| | | | frames other than PS-Poll frames transmitted |
| | | | during the CP, and under HCF for frames |
| | | | transmitted during the CFP |
| 0 | 0 | 1 | Fixed value under point coordination function |
| | | | (PCF) within frames transmitted during the CFP |
| 1-16383 | 0 | 1 | Reserved |
| 0 | 1 | 1 | Reserved |
| 1-2007 | 1 | 1 | AID in PS-Poll frames |
| 2008-16383 | 1 | 1 | Reserved |

Since the RA field 93 indicates an address of a receiving device, it may indicate an address of a STA or AP that cannot transmit a packet to an AP or STA receiving the frame 90 during the transmission deferring duration indicated by the duration/ID field 92, as described with reference to FIG. 6.

Since the TA field 94 indicates an address of a transmitting device, it may indicate an address of a STA or AP to which the transmission deferring duration indicated by the duration/ID field 92 is applied, as described with reference to FIG. 3.

The FCS field 95 may include a CRC, for example a 32-bit CRC, for checking the frame 90.

As described above, even if any frame of the control frame, the data frame, and the management frame is transmitted, the STA or AP can request to defer the transmission regardless of the type or subtype of the frame, by modifying the duration/ID field in the previous version frame format.

For example, the STA or AP may request to defer the transmission by modifying the duration/ID field of the data frame. In another example, the control frame of the previous version frame may be used as the transmission deferring request frame by revising the duration/ID field. In this case, a RTS frame (subtype of “1011”), a CTS frame (subtype of “1100”) or an ACK frame (subtype of “1101”) may be modified.

FIG. 10 schematically shows a frame format in a wireless communication network according to another embodiment of the present invention.

Referring to FIG. 10, a frame 100 includes a legacy frame part 101 and a HEW frame part 102. The frame 100 is a physical layer (PHY) frame and may be for example a PLCP (physical layer convergence procedure) frame.

The legacy frame part 101 is a part supporting the IEEE standard 802.11a or the IEEE standard 802.11g and includes a legacy short training field (L-STF), a legacy long training field (L-LTF), and a legacy signal field (L-SIG). The L-STF and the L-LTF is used for automatic gain control, synchronization, and channel estimation of the legacy frame part 101, and the L-SIG includes length and rate information.

The HEW frame part 102 is a part supporting a wireless communication network according to an embodiment of the present invention, i.e., a HEW and includes a signal field (HEW-SIG) and a data field. The HEW frame part 102 may further include a preamble, i.e., a training field for the HEW frame part 102.

The HEW-SIG includes a duration field and an address field. Each of the duration field and the address field may be allocated to some bits of the HEW-SIG. The duration field includes duration information indicating transmission deferring duration, and the address field includes address information of an AP or STA to which the transmission deferring duration indicated by the duration information is applied. In one embodiment, the address information may be an address of the AP or STA. In another embodiment, the address information may be a part of address of the AP or STA, or a compressed address of the AP or STA. In yet another embodiment, the address information may be an AID, a part of the AID, or a compressed value of the AID.

In some embodiments, the HEW-SIG may further include an RA field. The RA includes RA information indicating an address of an AP or STA that cannot transmit a packet to a STA or AP indicated by the address information during the transmission deferring duration indicated by the duration information. In one embodiment, the RA may be an address of the AP or STA. In another embodiment, the RA may be a part of address of the AP or STA, or a compressed address of the AP or STA.

In some embodiments, the HEW-SIG may further include a type field. The type field includes type information indicating whether the frame 100 is a transmission deferring request frame.

In some embodiments, the HEW-SIG may further include a BSS identifier (BSSID) field including BSSID information indicating a BSS to which the frame 100 belongs.

As described above, the AP or STA can identify the transmission deferring request frame by decoding the HEW-SIG needless to decode the data field. Therefore, the STA or AP transmitting the frame 100 can quickly enter the power saving mode.

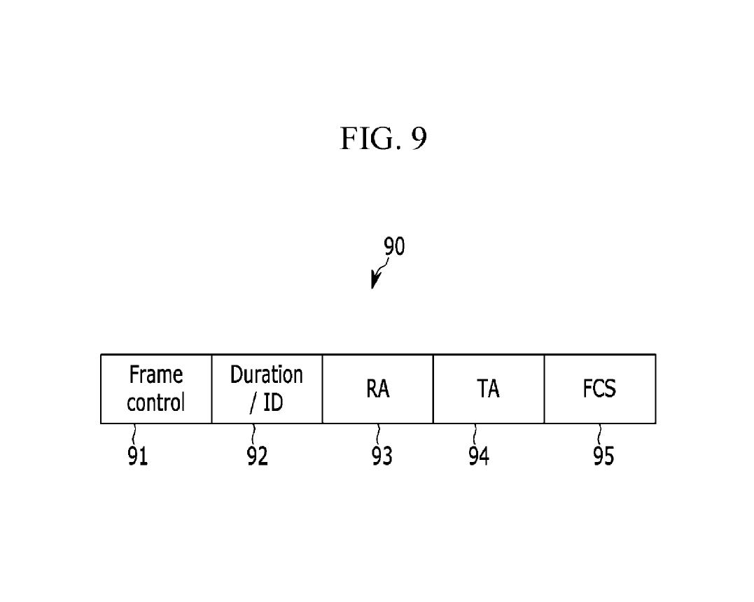

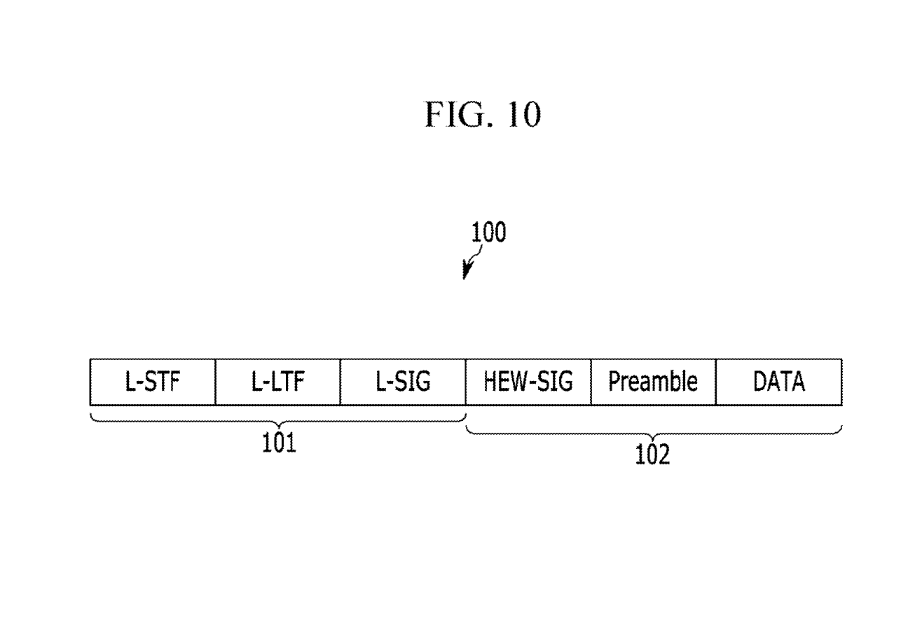

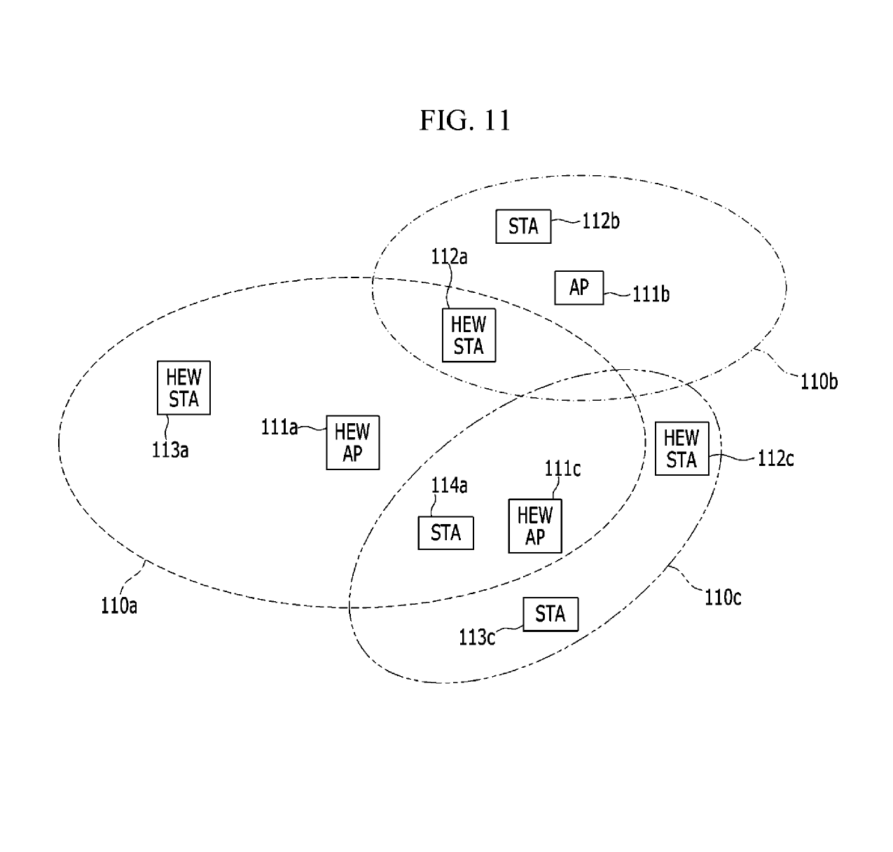

Next, a transmission deferring method according to an embodiment of the present invention is described with reference to FIG. 11 to FIG. 21.

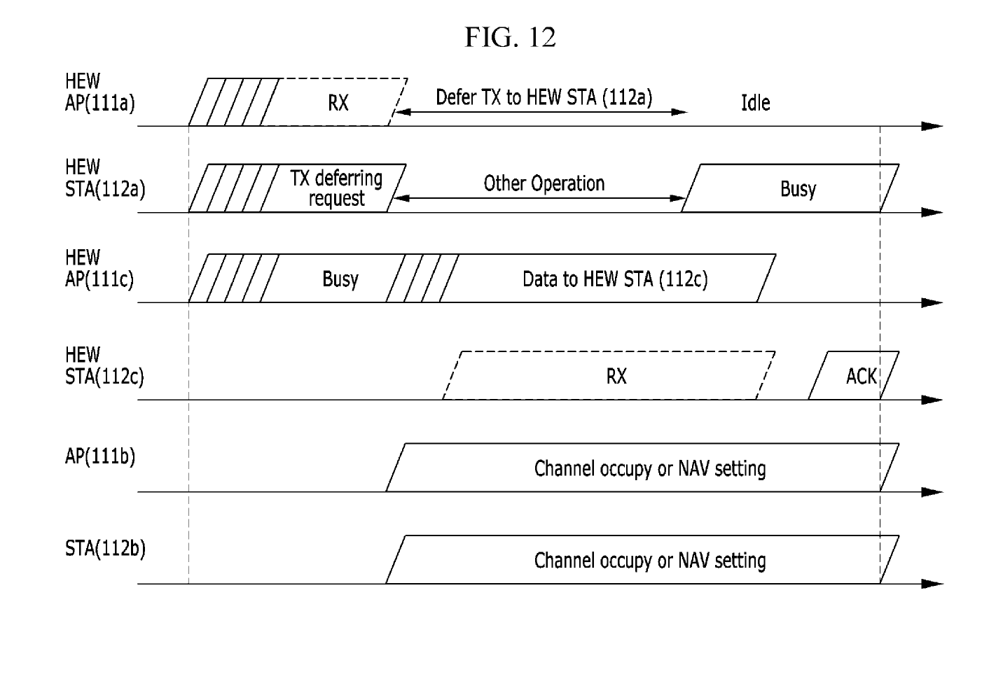

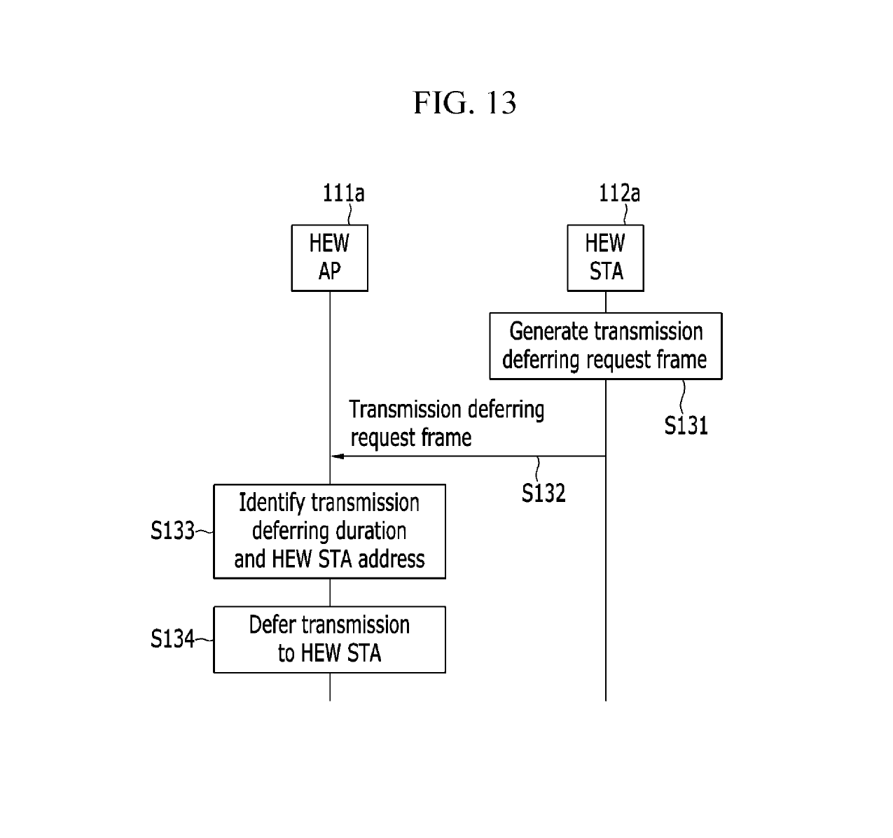

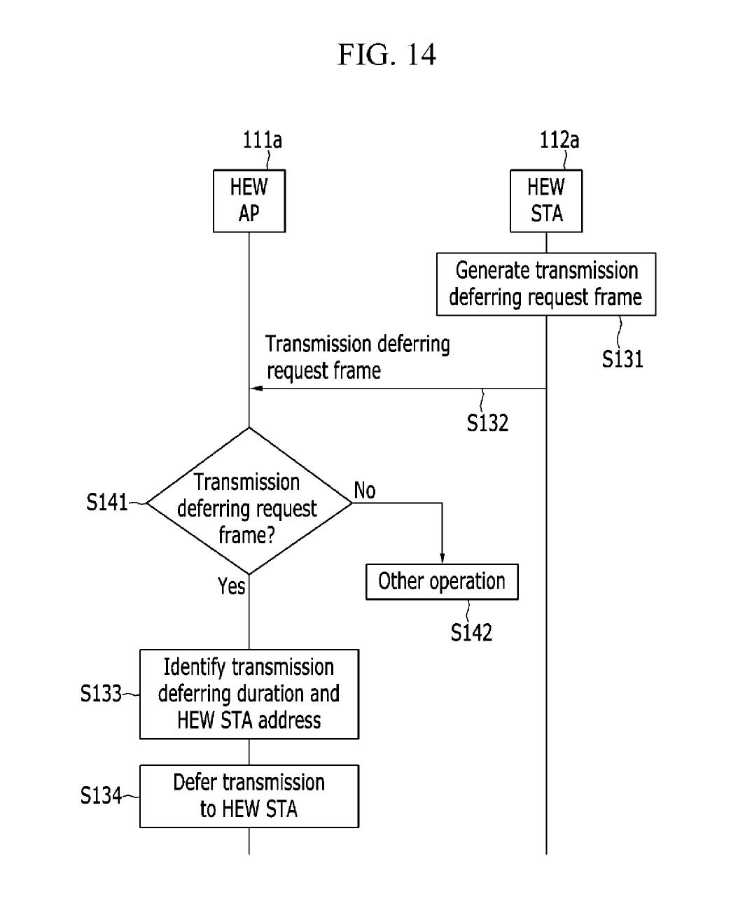

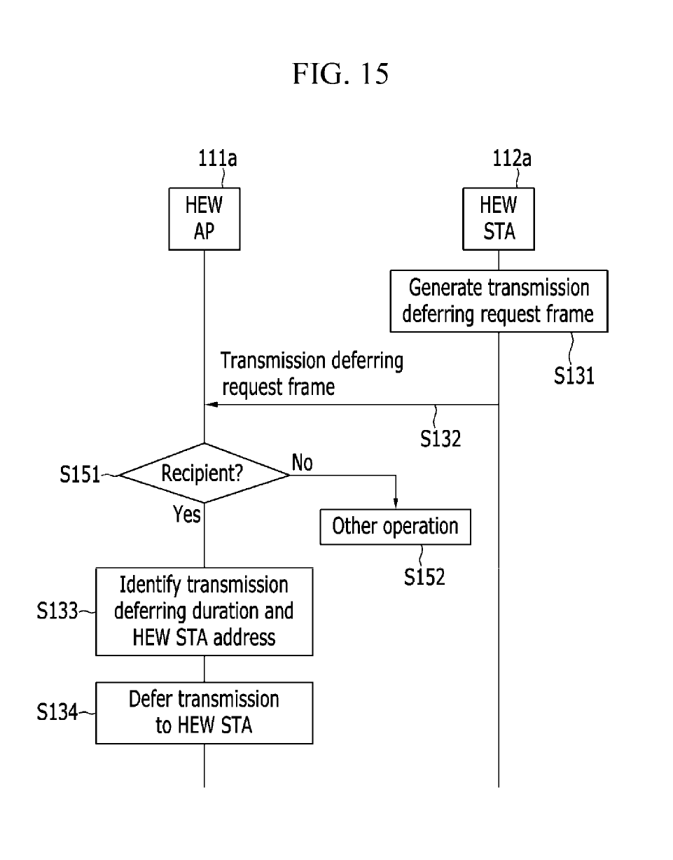

FIG. 11 is a drawing for explaining a transmission deferring method in a wireless communication network according to an embodiment of the present invention, FIG. 12 shows a transmission deferring request by a STA in a wireless communication network according to an embodiment of the present invention, and FIG. 13, FIG. 14, FIG. 15, and FIG. 16 each are a flowchart showing a transmission deferring method in a wireless communication network according to various embodiments of the present invention.

Referring to FIG. 11, a BSS 110a includes an AP 111a and STAs 112a, 113a, and 114a. A BSS 110b adjacent to the BSS 110a includes an AP 111b and a STA 112b, and a BSS 110c adjacent to the BSS 110a includes an AP 111c and STAs 112c and 113c. It is assumed that the APs 111a and 111c are HEW APs, the AP 111b is a previous version AP, the STAs 112a, 113a, and 112c are HEW STAs, and the STAs 114a, 112b, and 113c are previous version STAs. Further, it is assumed that the HEW AP 111a, the previous version STA 114a, the HEW AP 111c, the HEW STA 112c, the previous version AP 111b, and previous version STA 112b are within the coverage of the HEW STA 112a.

Referring to FIG. 11, FIG. 12, and FIG. 13, the HEW STA 112a belonging to the BSS 110a generates a transmission deferring request frame (S131) and transmits the generated transmission deferring request frame (S132). When generating the transmission deferring request frame, the HEW STA 112a inputs transmission deferring duration, for example duration corresponding to a power saving mode to a duration field of the frame, and inputs its address to an address field of the frame.

The HEW AP 111receiving the transmission deferring request frame identifies the transmission deferring duration and the address of a STA, i.e. the HEW STA 112a, targeted to defer transmission from the duration field and the address field, respectively (S133), and defers the transmission to the HEW STA 112a during the transmission deferring duration (S134). When a direct communication can be performed between the HEW STA 112a and the HEW STA 113a, the HEW STA 113a may also identify the transmission deferring duration and the address of the HEW STA 112a from the transmission deferring request frame, and may defer the transmission to the HEW STA 112a during the transmission deferring duration. Even if the direct communication can be performed between the HEW STA 112a and the STA 114a, the STA 114a operates regardless of the transmission deferring duration since it cannot interpret the transmission deferring request frame.

The HEW STA 112a can perform other operation since it does not need to receive a packet during the transmission deferring duration. For example, the HEW STA 112a may exchange Bluetooth packets with a Bluetooth device during the transmission deferring duration.

Even if the HEW AP 111c and the HEW STA 112c receive the transmission deferring request frame, they operate regardless of the transmission deferring duration since the HEW STA 112a does not belong to their BSS 110c. Further, the previous version AP 111b operates regardless of the transmission deferring duration since it cannot interpret the transmission deferring request frame. For example, when the HEW AP 111c detects energy in a channel and determines that the channel is not busy, it can occupy the channel regardless of the transmission deferring duration and transmit data to the HEW STA 112c. Further, the HEW STA 112c can transmit an acknowledgement (ACK) to the HEW AP 111c. Similarly, when the AP 111b detects the energy in the channel and determines that the channel is not busy, it can occupy the channel and transmit data to the STA 112b. Alternatively, the AP 111b or the STA 112b may set a NAV in accordance with an RTS frame or a CTS frame exchanged for occupying the channel between the HEW AP 111c and the HEW STA 112c.

In some embodiments, the HEW AP 111receiving the transmission deferring request frame may defer the transmission to the HEW STA 112a when the HEW STA 112a is associated with the HEW AP 111a. That is, the HEW AP 111may determine whether the address of the HEW STA 112a is included in a list of associated devices, and may receive and process the transmission deferring request frame when the address of the HEW STA 112a is included in the list.

Referring to FIG. 11 and FIG. 14, in another embodiment, a transmission deferring request frame transmitted by the HEW STA 112a may further include a frame control field. In this case, the HEW AP 111receiving the frame checks whether a type of the received frame is the transmission deferring request frame based on a frame control field (S141). When the received frame is the transmission deferring request frame, the HEW AP 111identifies transmission deferring duration and an address of the HEW STA 112a from a duration field and an address field, respectively (S133), and defers transmission to the HEW STA 112a during the transmission deferring duration (S134). When the received frame is not the transmission deferring request frame, the

HEW AP 111performs an operation according to the type of the received frame (S142).

Referring to FIG. 11 and FIG. 15, in yet another embodiment, a transmission deferring request frame transmitted by the HEW STA 112a may further include an RA field. In this case, a HEW AP 111receiving the frame identifies whether the HEW AP 111is a recipient of the transmission deferring request frame from the RA field (S151). Upon being the recipient of the transmission deferring request frame, the HEW AP 111identifies transmission deferring duration and an address of the HEW STA 112a from a duration field and an address field (S133), and defers the transmission to the HEW STA 112a during the transmission deferring duration (S134). As exemplified in Table 2, when the RA field has a value corresponding to an address of the HEW AP 111or a value indicating broadcast, for example “FFFFFFFFFFFF,” the HEW AP 111can determine that it is the recipient of the transmission deferring request frame. When the HEW AP 111is not the recipient of the transmission deferring request frame, the HEW AP 111performs the other operation (S152).

Referring to FIG. 11 and FIG. 16, in still another embodiment, a transmission deferring request frame transmitted by the HEW STA 112a may further include a response indication field. In this case, the HEW AP 111identifies transmission deferring duration and an address of the HEW STA 112a from a duration field and an address field (S133), and checks whether the response indication field requests a response (S161). The step S133 for identifying the duration field and the address field and the step S161 for checking the response indication field may be simultaneously performed. Alternatively, any one of the steps S133 and S161 may be first performed. When the response indication field requests the response (S162), the HEW AP 111a transmits a response frame to the HEW STA 112a (S163), and then defers the transmission to the HEW STA 112a during the transmission deferring duration (S134). When the response indication field does not request the response (S162), the HEW AP 111defers the transmission to the HEW STA 112a during the transmission deferring duration without transmitting the response frame (S134).

In some embodiments, the HEW AP 111may receive the transmission deferring request frame and then transmit the response frame after the IFS interval. For examples, when the transmission deferring request frame is a management frame or a data frame, the HEW AP 111receiving the transmission deferring request frame may transmit after performing backoff if a DIFS or PIFS interval has elapsed. In this case, the HEW STA 112a may not quickly enter the power saving mode since the HEW STA 112a cannot know when the response frame is received. Alternatively, the HEW AP 111may transmit the response frame without performing backoff if the SIFS interval has elapsed. In this case, a frame modifying an ACK frame (type “01” and subtype “1101” in Table 1) may be used as the response frame. When the transmission deferring request frame is a control frame, the HEW AP 111receiving the transmission deferring request frame may transmit the response frame without performing backoff if the SIFS interval has elapsed.

As described above, the HEW STA can operate in the power saving mode during a desired period, in particular, a short period, by transmitting the transmission deferring request frame. Further, the HEW STA can perform the other operation without having an influence on operations of the other devices since the HEW STA can defer the transmission of packets to be transmitted to the HEW STA during the power saving mode. Accordingly, channels of a wireless communication network can be efficiently used. Furthermore, when a single chipset into which the WLAN module and the other communication module are incorporated is used, the HEW STA can enter the power saving mode by allowing the other communication module, for example the Bluetooth module, to be operated.

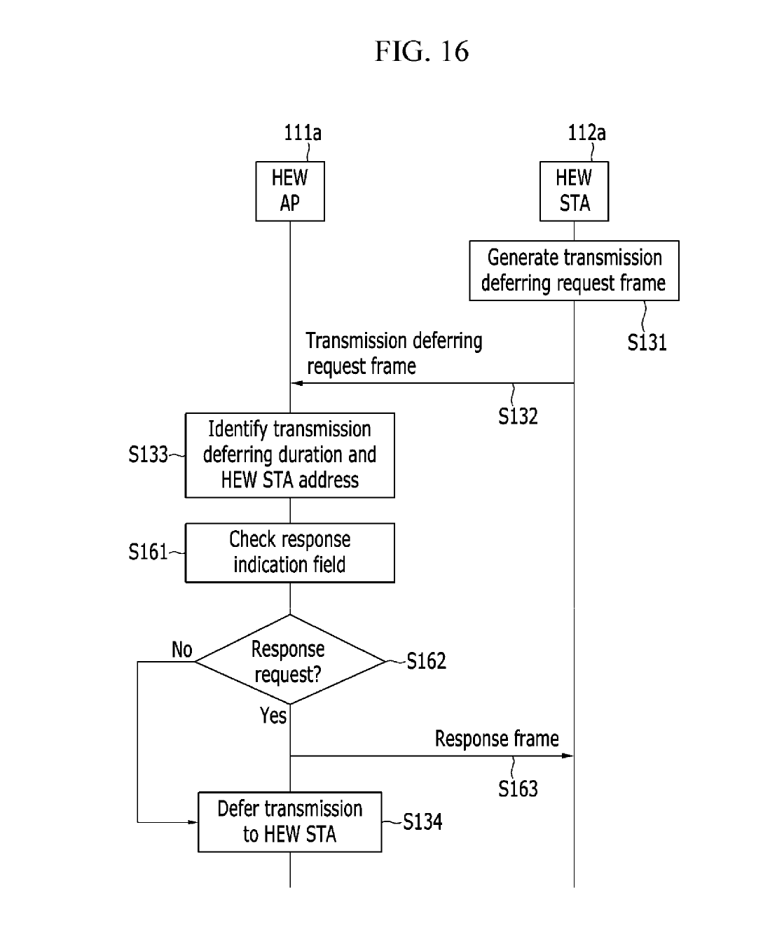

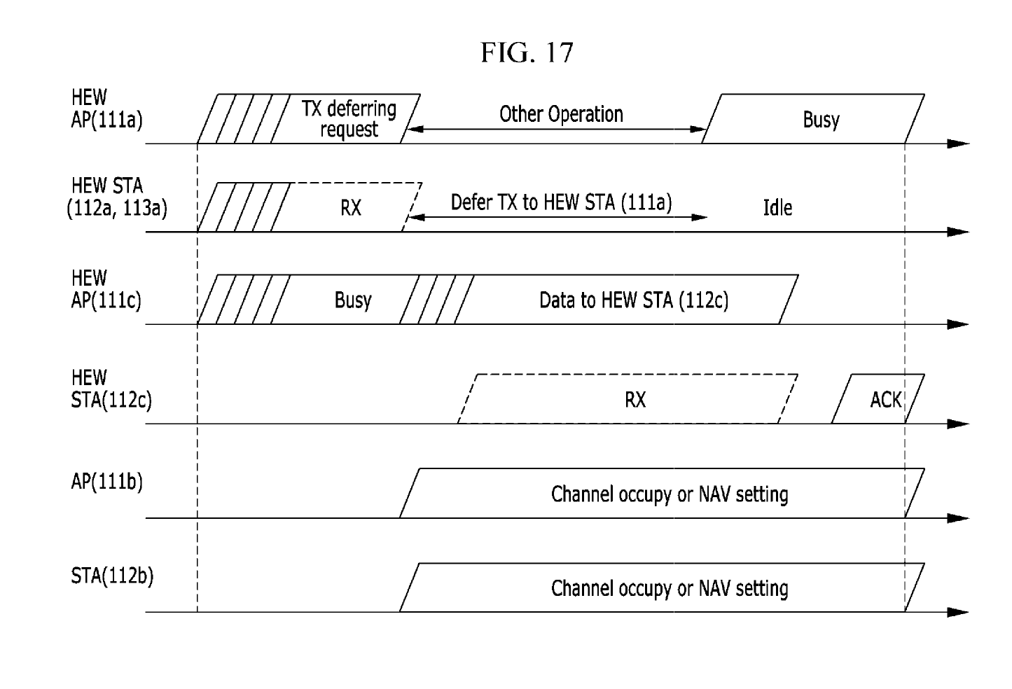

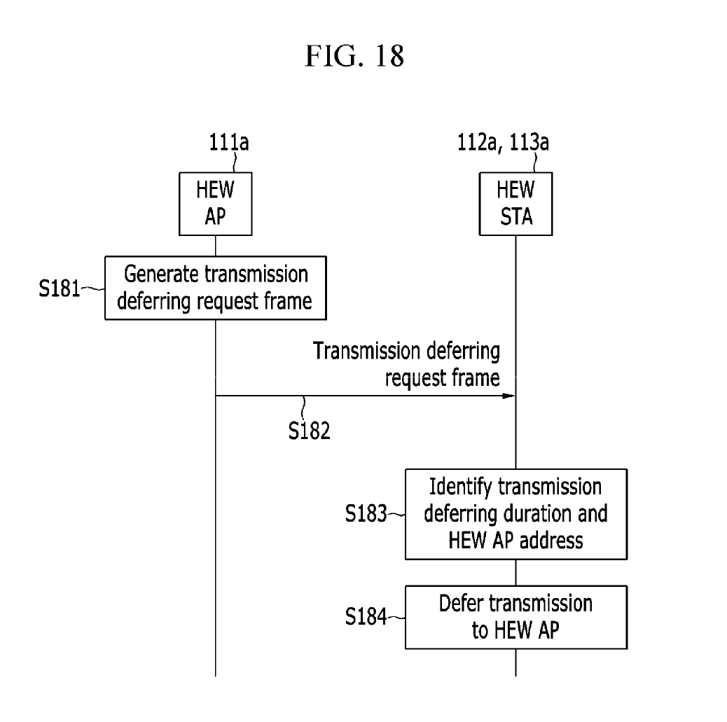

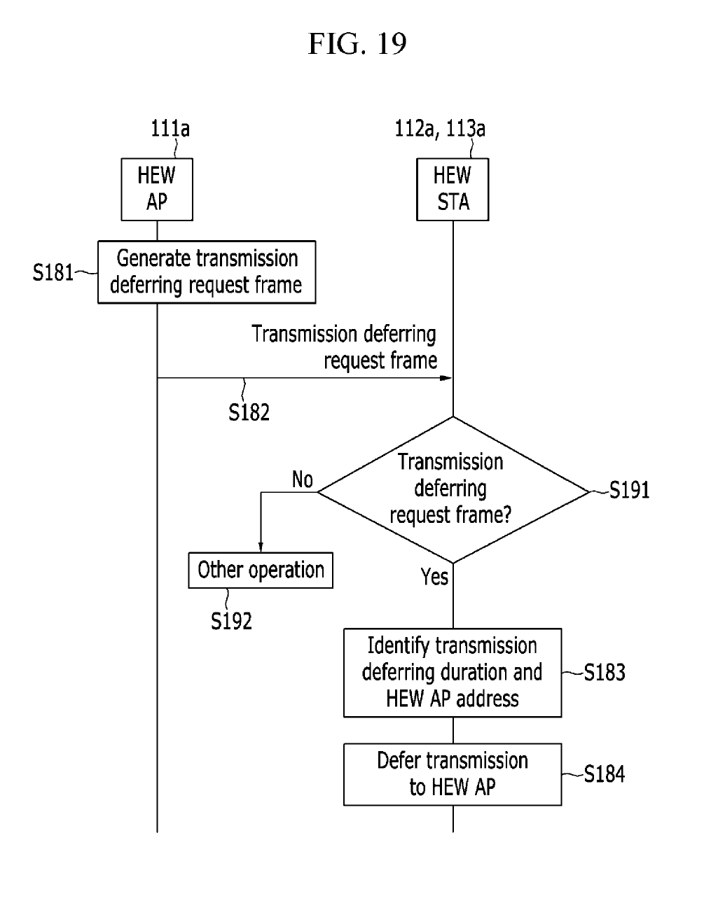

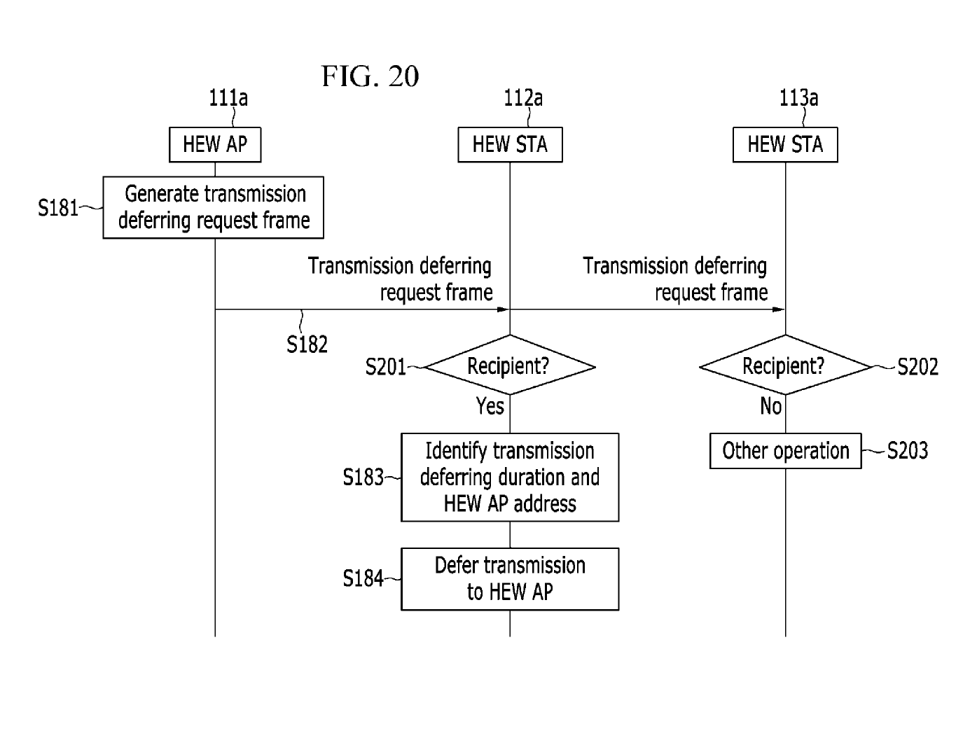

FIG. 17 shows a transmission deferring request by an AP in a wireless communication network according to an embodiment of the present invention, and FIG. 18, FIG. 19, FIG. 20, and FIG. 21 each are a flowchart showing a transmission deferring method in a wireless communication network according to various embodiments of the present invention.

Referring to FIG. 11, FIG. 17, and FIG. 18, a HEW AP 111belonging to a BSS 110a generates a transmission deferring request frame (S181) and transmits the generated transmission deferring request frame (S182). The HEW AP 111inputs transmission deferring duration, for example duration corresponding to a power saving mode to a duration field of the frame, and inputs its address to an address field of the frame.

HEW STAs 112a and 113a receiving the transmission deferring request frame identify the transmission deferring duration and the address of the HEW AP 111a, targeted to defer transmission from the duration field and the address field, respectively (S183), and defer the transmission to the HEW AP 111during the transmission deferring duration (S184). Accordingly, the HEW AP 111can perform other operation since it does not need to receive a packet during the transmission deferring duration. For example, the HEW AP 111may exchange Bluetooth packets with a Bluetooth device during the transmission deferring duration.

A previous version STA 114a operates regardless of the transmission deferring duration since it cannot interpret the transmission deferring request frame. Even if a

HEW AP 111c receives the transmission deferring request frame, the HEW AP 111c operate regardless of the transmission deferring duration since the HEW AP 111does not belong to their BSS 110c. Further, a previous version AP 111b operates regardless of the transmission deferring duration since it cannot interpret the transmission deferring request frame.

In some embodiments, the HEW STAs 112a and 113a may defer the transmission to the HEW AP 111when the HEW AP 111is an AP with which the HEW STAs 112a and 113a have associated. That is, the HEW STAs 112a and 113a may determine whether the HEW AP 111is the associated AP based on the BSSID, and may receive and process the transmission deferring request frame when the HEW AP 111is the associated AP.

Referring to FIG. 11 and FIG. 19, in another embodiment, a transmission deferring request frame transmitted by the HEW AP 111may further include a frame control field. In this case, the HEW STAs 112a and 113a receiving the frame check whether a type of the received frame is the transmission deferring request frame based on a frame control field (S191). When the received frame is the transmission deferring request frame, the HEW STAs 112a and 113a identify transmission deferring duration and an address of the HEW AP 111from a duration field and an address field, respectively (S183), and defer transmission to the HEW AP 111during the transmission deferring duration (S184). When the received frame is not the transmission deferring request frame, the HEW STAs 112a and 113a perform an operation according to the type of the received frame (S192).

Referring to FIG. 11 and FIG. 20, in yet another embodiment, a transmission deferring request frame transmitted by the HEW AP 111may further include an RA field. In this case, a HEW STAs 112a and 113a receiving the frame identify whether the HEW STA 112a or 113a is a recipient of the transmission deferring request frame from the RA field (S201 and S202). Upon being the recipient of the transmission deferring request frame, the HEW STA 112a or 113a identifies transmission deferring duration and an address of the HEW AP 111from a duration field and an address field (S183), and defers the transmission to the HEW AP 111during the transmission deferring duration (S184). As exemplified in Table 2, when the RA field has a value corresponding to an address of the HEW STA 112a or a value indicating broadcast, for example “FFFFFFFFFFFF,” the HEW STA 112a can determine that it is the recipient of the transmission deferring request frame. For example, when the RA field has a value corresponding to the address of the HEW STA 112a, the HEW STA 113a performs other operation regardless of the transmission deferring request frame since the HEW STA 113a is not the recipient of the transmission deferring request frame (S203).

Referring to FIG. 11 and FIG. 21, in still another embodiment, a transmission deferring request frame transmitted by the HEW AP 111may further include a response indication field. In this case, the HEW STAs 112a and 113a identify transmission deferring duration and an address of the HEW STA 112a from a duration field and an address field (S183), and check whether the response indication field requests a response (S211). The step S183 for identifying the duration field and the address field and the step S211 for checking the response indication field may be simultaneously performed. Alternatively, any one of the steps S183 and S211 may be first performed. When the response indication field requests the response (S212), the HEW STAs 112a and 113a transmit a response frame to the HEW AP 111(S213), and then defers the transmission to the HEW AP 111a. When the response indication field does not request the response (S212), the HEW STAs 112a and 113a defer the transmission to the HEW AP 111during the transmission deferring duration without transmitting the response frame (S184).

In some embodiments, the HEW STAs 112a and 113a may receive the transmission deferring request frame and then transmit the response frame after the IFS interval.

As described above, the HEW AP can operate in the power saving mode during a desired period, in particular, a short period, by transmitting the transmission deferring request frame. Further, the HEW AP can prevent STAs within the BSS from performing uplink transmissions through the transmission deferring request frame such that channels can be efficiently used.

Furthermore, as described with reference to FIG. 20, the HEW AP can transmit the transmission deferring request frame by inputting an address or an AID of a specific STA to the RA field. As a result, the HEW AP can perform a quality of service (QoS) control by preventing the specific STA from performing the uplink transmission. Accordingly, when the network performance is deteriorated by the specific STA generating a lot of traffics within the BSS, the HEW AP can improve the network performance by preventing the specific STA from performing the uplink transmission.

Next, a transmission deferring apparatus in a wireless communication network according to an embodiment of the present invention is described with reference to FIG. 20.

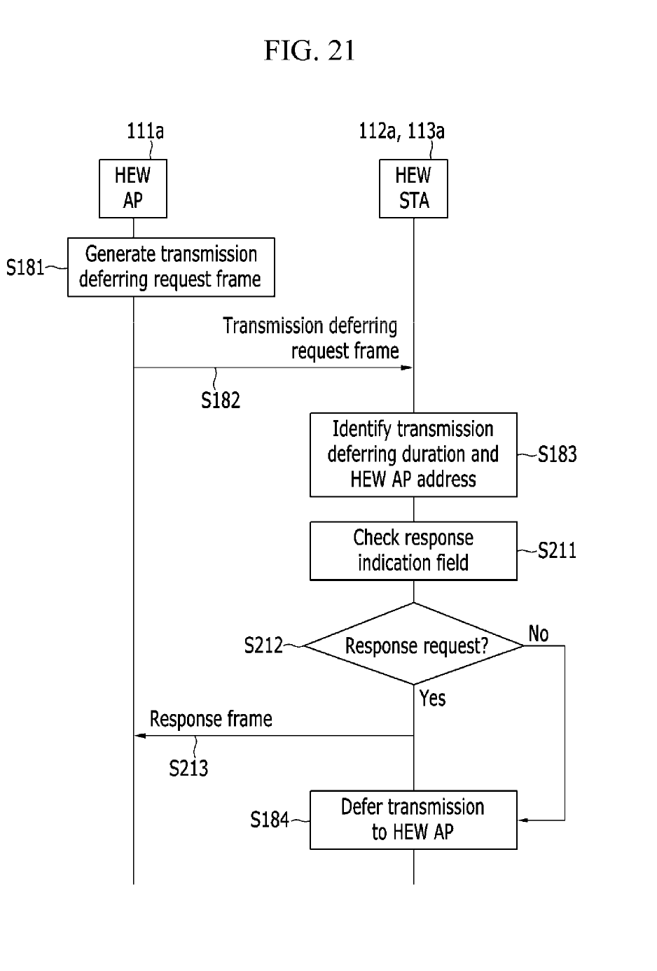

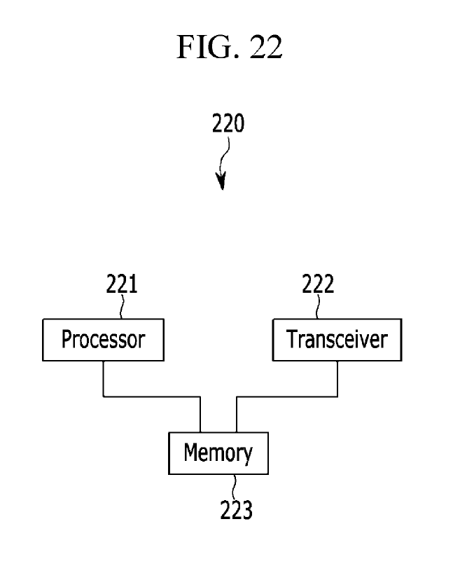

FIG. 22 is a schematic block diagram showing a transmission deferring apparatus in a wireless communication network according to an embodiment of the present invention.

Referring to FIG. 22, a transmission deferring apparatus 220 includes a processor 221, a transceiver 222, and a memory 223. The transmission deferring apparatus 220 may be an AP or a STA, or may be included in the AP or the STA.

The processor 221 generates a transmission deferring request frame including a duration field and an address field when deferring reception of packets during a predetermined period. The transmission deferring request frame may further include a frame control field, an RA field, a response indication field, and/or a response field. When the transmission deferring request frame is received, the processor 221 detects information the transmission deferring from fields of the transmission deferring request frame. Then, the processor 221 defers transmission to a device corresponding to an address field during duration indicated by a duration field

The transceiver 222 transmits the transmission deferring request frame, or receives the transmission deferring request frame from the other AP or STA. When the AP or STA includes other communication module as well as a WLAN module, one transceiver 222 may support both the WLAN module and the other communication module.

The memory 223 stores instructions to be executed by the processor 221 or loads and stores the instructions from a storage device (not shown). The processor 221 executes the instructions that are stored or loaded in the memory 223.

The processor 221 and the memory 223 may be connected via a bus (not shown), and an input/output interface (not shown) may be connected to the bus. The transceiver 222 may be connected to the input/output interface, and peripheral devices such as an input device, a display device, a speaker, and the storage device may be connected to the input/output interface.

While this disclosure has been described in connection with what is presently considered to be practical embodiments, it is to be understood that the invention is not limited to the disclosed embodiments, but, on the contrary, is intended to cover various modifications and equivalent arrangements included within the spirit and scope of the appended claims. Further, two or more embodiments may be combined.

What is claimed is:

1. A transmission deferring method by a device in a wireless local area network (WLAN), the method comprising:
receiving a frame including duration information indicating transmission deferring duration and address information indicating an address of a target device for the transmission deferring duration; and
deferring a transmission to the target device during the transmission deferring duration.

2. The method of claim 1, wherein receiving the frame includes receiving the frame when the device is associated with the target device.

3. The method of claim 1, wherein the frame further includes type information, and
wherein deferring the transmission includes
checking the type information of the frame, and
deferring the transmission to the target device during the transmission deferring duration when the type information indicates a frame requesting transmission deferring.

4. The method of claim 1, wherein the frame further includes response indication information, and
wherein deferring the transmission includes
checking the response indication information of the frame,
transmitting a response frame to the target device when the response indication information requests a response, and
deferring the transmission to the target device during the transmission deferring duration after transmitting the response frame.

5. The method of claim 1, wherein the frame further includes receiver address information, and
wherein deferring the transmission includes
checking the receiver address information of the frame, and
deferring the transmission to the target device during the transmission deferring duration when the receiver address information indicates an address of the device.

6. The method of claim 5, wherein checking the receiver address information of the frame includes determining that the receiver address information indicates the address of the device when the receiver address information has a value corresponding to the address of the device or a predetermined value.

7. The method of claim 6, wherein the frame further includes response indication information, and
wherein deferring the transmission includes
checking the response indication information of the frame,
transmitting a response frame to the target device when the response indication information requests a response and the receiver address information has the value corresponding to the address of the device, and
deferring the transmission to the target device during the transmission deferring duration after transmitting the response frame.

8. The method of claim 1, wherein the frame is a medium access control (MAC) frame.

9. The method of claim 8, wherein the frame has a same format a frame defined in IEEE Std 802.11-2012,
wherein the duration information is assigned to a reserved value in a duration/ID field of a frame defined in IEEE Std 802.11-2012, and
wherein the address information is assigned to a receiver address (RA) field of a frame defined in IEEE Std 802.11-2012.

10. The method of claim 1, wherein the frame is a physical layer frame, and
wherein the duration information and the address information are assigned to a signal field of the physical layer frame.

11. A transmission deferring method by a device in a wireless local area network (WLAN), the method comprising:
generating a frame including duration information indicating transmission deferring duration and address information indicating an address of a target device requesting transmission deferring during the transmission deferring duration; and
transmitting the frame.

12. The method of claim 11, wherein the frame further includes type information indicating that the frame has a type requesting the transmission deferring.

13. The method of claim 11, wherein the frame further includes response indication information requesting a response on the frame.

14. The method of claim 11, wherein the frame further includes receiver address information indicating a receiving device for deferring a transmission to the target device.

15. The method of claim 14, wherein the receiving device defers the transmission to the target device during the transmission deferring duration when the receiver address information has a value corresponding to the address of the device or a predetermined value.

16. The method of claim 15, wherein the frame further includes response indication information requesting a response on the frame, and
the receiving device transmits the response to the device when the receiver address information has the value corresponding to the address of the device.

17. The method of claim 11, wherein the frame is a medium access control (MAC) frame.

18. The method of claim 17, wherein the frame has a same format a frame defined in IEEE Std 802.11-2012,
wherein the duration information is assigned to a reserved value in a duration/ID field of a frame defined in IEEE Std 802.11-2012, and
wherein the address information is assigned to a receiver address (RA) field of a frame defined in IEEE Std 802.11-2012.

19. The method of claim 11, wherein the frame is a physical layer frame, and
wherein the duration information and the address information are assigned to a signal field of the physical layer frame.

20. A transmission deferring apparatus in a wireless local area network (WLAN), the apparatus comprising:
a transceiver configured to receive a frame including duration information indicating transmission deferring duration and address information indicating an address of a target device for the transmission deferring duration; and
a processor configured to defer a transmission to the target device during the transmission deferring duration.
